(19) United States
(12) Patent Application Publication
(10) Pub. No.: US 2026/0212393 A1
(43) Pub. Date: Jul. 23, 2026

(54) SYSTEM AND METHOD FOR A GLOBAL VISUAL CONTENT MARKETPLACE POWERED BY GEO-LOCATION AND ARTIFICIAL INTELLIGENCE

(71) Applicants: ANITA ASABE ISIOMA VINCENT-OTIONO, Los Angeles, CA (US); ABDUSSAMAD USMAN, Lagos (NG)

(72) Inventors: ANITA ASABE ISIOMA VINCENT-OTIONO, Los Angeles, CA (US); ABDUSSAMAD USMAN, Lagos (NG)

(21) Appl. No.: 19/458,262

(22) Filed: Jan. 23, 2026

Related U.S. Application Data
(60) Provisional application No. 63/748,555, filed on Jan. 23, 2025.

(51) Int. Cl. G06Q 30/0601

(52) U.S. Cl. CPC G06Q 30/0601

(57) ABSTRACT

The system and method for a global visual content marketplace powered by geo-location and artificial intelligence leverages machine learning, geo-location technologies, and artificial intelligence to curate, distribute, and manage stock visual content. This system enables users to access, contribute to, and purchase visual content in a highly personalized and efficient manner, addressing the needs of diverse stakeholders including content creators, marketers, and publishers.

### CROSS-REFERENCE TO RELATED APPLICATIONS

This application claims the benefit of U.S. Provisional Application Ser. No. 63/748,555, filed on Jan. 23, 2025, which is incorporated herein by reference.

### TECHNICAL FIELD

The present disclosure relates to a digital content management and distribution system. More particularly, the present disclosure relates to a digital content management and distribution system that focuses on multimedia content, such as images and videos, facilitated through an online marketplace.

### BACKGROUND

The stock photo industry began around 1920 with the hope that photographers would increase their incomes. The industry drove companies to set up photography licensing agencies and archives. As technology progressed throughout the world, the licensing and dissemination of photography has changed considerably. The proliferation of digital media has escalated the demand for high-quality, relevant, and easily accessible visual content.

Many contemporary stock photo companies have attempted to adjust to these demands. However, these attempts have often fallen short and due to these shortcomings, many consumers are left desiring more from these agencies. In particular, traditional stock photo libraries and content marketplaces often lack real-time relevancy, personalization, and efficient discovery mechanisms. Consequently, content creators are forced to seek more effective ways to monetize and distribute their work.

Accordingly, there is a need for a visual content marketplace system that allows users to have personalization, efficient discovery mechanisms, and real-time relevancy. The present invention seeks to solve these and other problems.

### SUMMARY OF EXAMPLE EMBODIMENTS

In one embodiment, the system and method for a global visual content marketplace powered by geo-location and artificial intelligence integrates a stock visual library powered by machine learning algorithms, a geo-location-based marketplace, and an AI-driven curation productivity tool. The system may function and a user may utilize it in the following manner. A user (e.g., storyteller) uses the system to upload their content. Then a user interface interacts with a portfolio module in the system where the content is uploaded to the backend thereof. The portfolio contacts and communicates with a content module to check the moderation labels of the content before the content is allowed to upload to a portal. A single portfolio may have one attachment or multiple attachments within the system. The portfolio may then store the content details in a service that stores data in tables (e.g., DynamoDB), and uploads the file to a simple storage service (e.g., S3) in a private bucket. The portfolio sends a work payload to a communication software (e.g., AWS SQS) to trigger the content module workflows. The system content starts the label extractor workflow for images. A workflow starts for a single portfolio, then for each attachment in one portfolio. There is a single sub workflow for each asset management, so in a single workflow, labels are collected and aggregated and then stored in the database against the asset. Labels are then collected with confidence ranging from 40% to 100%, which leads to creation of the text search blob. The asset is built and the existing database is updated. DynamoDB event streams on insert/update and streams event connected to a compute service (e.g., Lambda) to an SQS, which is being obtained by a search-feeds module. Then the asset is registered with the defined details in a search service (e.g., AWS Kendra) as a Document. Query suggestions are created that are trending query from Kendra. As the explicit checks are completed and the content is of platform standard, processing the media asset to different formats for user interface supports begins. The images may be processed with GaLanf Bimg library locally and placed in the S3, the formats are in the drawing. Videos are converted with a service that transcodes video files (e.g., AWS Elemental Media Convert) for different formats. Ultimately, all processed outputs are stored in the S3 private path, where they are exposed with a content delivery network (CDN) service CloudFront. This is where users may view these assets through Cloudfront

### BRIEF DESCRIPTION OF THE DRAWINGS

FIG. 1 illustrates a diagram of a system and method for a global visual content marketplace powered by geo-location and artificial intelligence;

FIG. 2 illustrates a block diagram of a system and method for a global visual content marketplace powered by geo-location and artificial intelligence; and

FIG. 3 illustrates a block diagram of a system and method for a global visual content marketplace powered by geo-location and artificial intelligence.

### DETAILED DESCRIPTION OF EXAMPLE EMBODIMENTS

While embodiments of the present disclosure may be subject to various modifications and alternative forms, specific embodiments have been shown by way of example in the drawings and will be described in detail herein. However, the present disclosure is not intended to be limited to the particular features, forms, components, etc. disclosed. Rather, the present disclosure will cover all modifications, equivalents, and alternatives falling within the scope of the present disclosure.

Reference to the invention, the present disclosure, or the like are not intended to restrict or limit the invention, the present disclosure, or the like to exact features or steps of any one or more of the exemplary embodiments disclosed herein. References to “one embodiment,” “an embodiment,” “alternate embodiments,” “some embodiments,” and the like, may indicate that the embodiment(s) so described may include a particular feature, structure, or characteristic, but not every embodiment necessarily includes the particular feature, structure, or characteristic.

Any arrangements herein are meant to be illustrative and do not limit the invention's scope. Although specific terms are employed herein, they are used in a generic and descriptive sense only and not for purposes of limitation. Unless otherwise defined herein, such terms are intended to be given their ordinary meaning not inconsistent with that applicable in the relevant industry and without restriction to any specific embodiment hereinafter described. Certain terms are used herein, such as “comprising” and “including,” and similar terms are meant to be “open” and not “closed” terms.

It will be understood that the steps of any such processes or methods are not limited to being carried out in any particular sequence, arrangement, or with any particular graphics or interface. In fact, the steps of the disclosed processes or methods generally may be carried out in various, different sequences and arrangements while still being in the scope of the present invention.

Portions of the system may be implemented wholly in hardware, wholly in software or combining software and hardware implementation that may all generally be referred to herein as a “circuit,” “module,” “component,” or “system.” It will be understood that computer program code for carrying out operations for features of the music playlist creation system on a smart device may be written in any programming language, which may include, but is not limited to, Objective-C, C++, C#, VB.NET, Java, Python, “C” programming language, Visual Basic, Perl, COBOL 2002, PHP, ABAP, Python, PHP, HTML, AJAX, or Ruby and Groovy. The program code may operate any portion of the system.

Portions of the system are illustrated in flowcharts and/or block diagrams. These flowcharts and/or block diagrams depict computer and mobile application program products according to embodiments of the system described herein. It will be understood that each block of the flowchart illustrations and/or block diagrams, and combinations of blocks in the flowchart illustrations and/or block diagrams, can be implemented by computer or mobile application program instructions.

As previously described, there is a need for a visual content marketplace system that allows users to have personalization, efficient discovery mechanisms, and real-time relevancy. The present invention seeks to solve these and other problems.

As technology progressed throughout the world, the licensing and dissemination of photography has changed considerably. The proliferation of digital media in hobbies, careers, etc. has escalated the demand for high-quality, relevant, and easily accessible visual content. Many contemporary stock photo companies have attempted to adjust to these demands. However, these attempts have often fallen short and due to these shortcomings, many consumers are left desiring more from these agencies. In particular, traditional stock photo libraries and content marketplaces often lack real-time relevancy, personalization, and efficient discovery mechanisms. Accordingly, content creators are forced to seek more effective ways to monetize and distribute their work.

The system for a global visual content marketplace powered by geo-location and artificial intelligence described herein includes machine learning, geo-location technologies, and artificial intelligence to curate, distribute, and manage stock visual content. It will be appreciated that this system enables users to access, contribute to, and purchase visual content in a highly personalized and efficient manner, addressing the needs of diverse stakeholders including content creators, marketers, and publishers. It will further be appreciated that the system represents a significant advancement in the field of digital content distribution and management, offering a scalable, efficient, and user-friendly platform for accessing and monetizing visual content worldwide. Through its innovative use of machine learning, AI, and geo-location technologies, it addresses critical gaps in the current market, offering benefits to content creators, marketers, and consumers alike.

In one embodiment, a system and method for a global visual content marketplace powered by geo-location and artificial intelligence (hereinafter referred to as the “system”) utilizes machine learning, geo-location technologies, and artificial intelligence to curate, distribute, and manage stock visual content. The system allows for the discovery, acquisition, and distribution of visual content. The machine learning within the system powers a stock visual library and includes algorithms to classify, tag, and recommend visual content to a user, thereby enhancing discoverability and relevance based on user preferences and behaviors. The geo-location marketplace within the system focuses on geo-location technology to offer localized content, enabling users to find or request visual content specific to locations, thereby catering to location-based marketing and content creation needs. The artificial intelligence within the system includes an artificial intelligence curation productivity tool that assists users in content selection, optimization, and management, streamlining workflows and enhancing productivity for content users and creators.

It will be appreciated that users of the system will be able to control and manipulate the type of content that is recommended to them. In particular, the system includes a method for recommending visual content based on a specific user's engagement history with the system, which method may be undertaken by a machine learning-powered recommendation engine. The engine is configured to analyze interaction between a user and the system. Some of these interactions may include, but are not limited to, clicks, likes, and shares. After analyzation of the interactions, the machine-learning engine tailors and produces content recommendations for the user, enhancing user engagement and platform personalization. The system is also configured to convert and deliver visual content in multiple formats and sizes, thereby optimizing the content based on the user's device specifications, screen size, and internet bandwidth. With this, a security measure is included to prevent unauthorized access to the original content, that ensures only purchased content is delivered in its original format, thereby protecting the copyright and original creation.

The system is also configured to utilize an automated pipeline that preforms a series of operations on uploaded content including the following: (1) Utilizing machine learning models to ensure uploaded content adheres to platform standards by identifying and filtering out not safe for work (NSFW) content; (2) Employing object detection and caption generation models to extract and tag visual elements and context from the uploaded content. This step is augmented by user contributions to enhance tag accuracy and searchability for all users; and (3) Extracting and indexing metadata from the content, such as camera settings and image dimensions, to enrich content descriptions and improve search functionality; and (4) Adapting content into various formats for optimized delivery based on user-specific criteria without compromising content security. While these specific operations are discussed, it will be understood that there may be more or less than four operations performed on uploaded content.

The system may also use a natural language processing (NLP)-based search engine capable of understanding and processing synonyms and contextual sentences This allows any user to find content through diverse query inputs, creating a personalized experience.

Further, the system allows geo-location-based job features, meaning clients may post job requests and find creators in specific locations, which lead to local content creation and collaboration. With the system allowing job requests, the system may further create job descriptions via artificial intelligence. An artificial intelligence tool with the system is designed to assist users in creating detailed job descriptions through guided questions that simplify the job posting process and enhances the user's experience.

Another feature of the system is an integrated wallet and escrow service. This service creates a financial transaction system that is incorporated therein and links to a payment gateway that supports multi-country transactions in United States dollars. It will be appreciated that this allows secure project financing and satisfaction before funds are released. It will be understood the system assists user in the content licensing and creation arena by its AI-driven content recommendation and processing to its user-centric features, such as adaptive content formatting, enhanced search capabilities, and comprehensive job and financial transaction services. This system improves the accessibility, personalization, and security of visual content distribution and monetization.

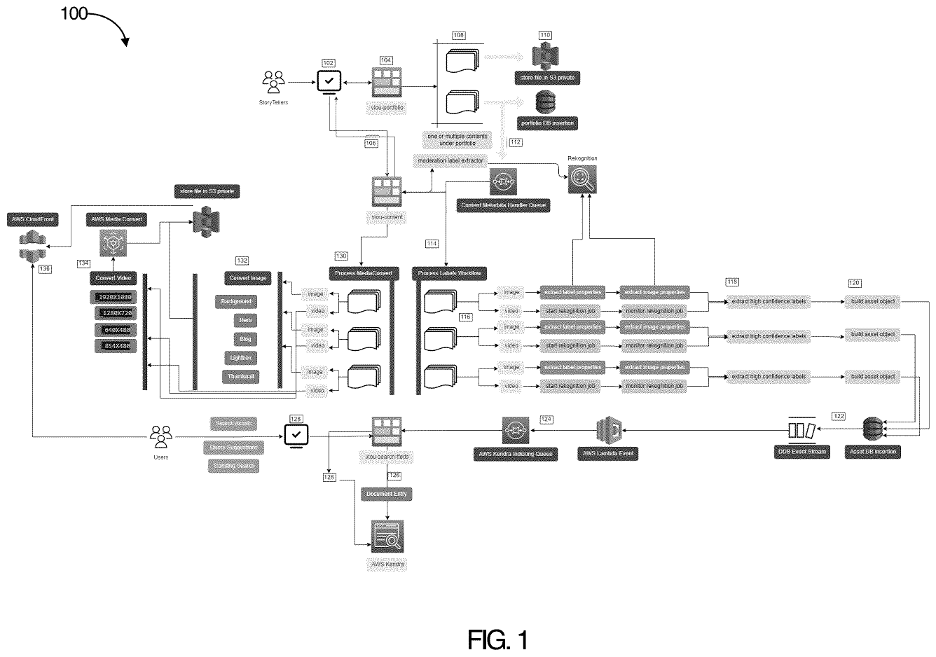

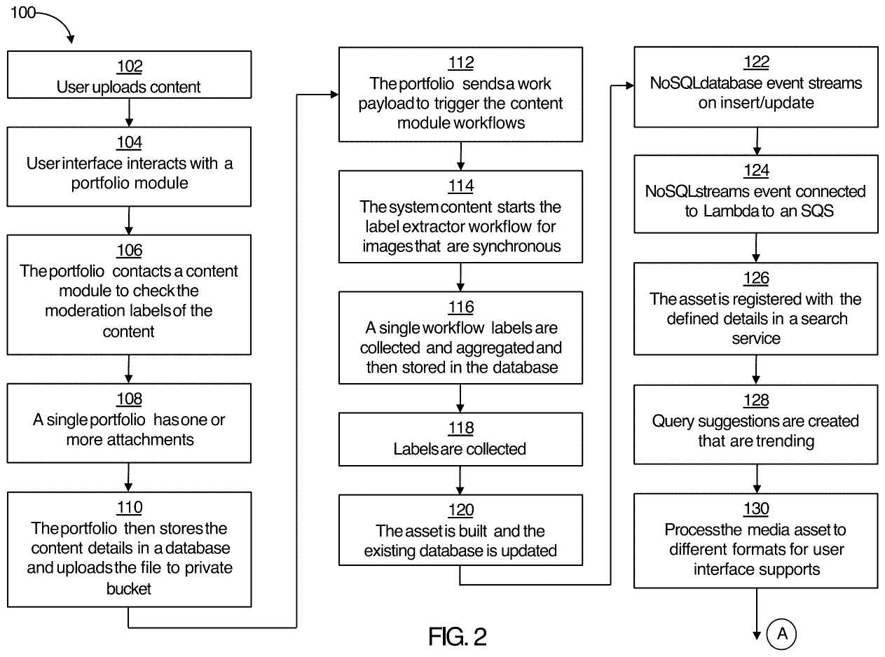

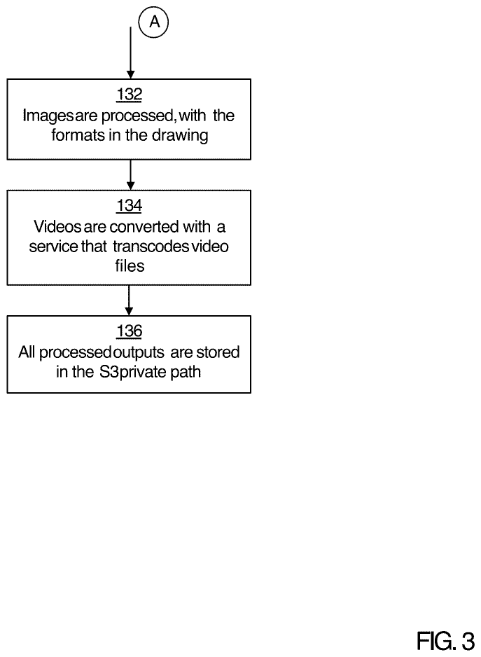

As shown in FIGS. 1-3, the system may function and a user may utilize it in the following manner. At step 102, a user (e.g., storyteller/content creators) uses the system to upload their content, whether an image, video, etc. At step 104, a user interface interacts with a portfolio module in the system where the content is uploaded to the backend thereof. The portfolio contacts and communicates with a content module to check the moderation labels (i.e., labels that add context or caution) of the content before the content is allowed to upload to a portal, at step 106. In some embodiments, a content module functions with AWS Rekognition, a cloud-based software that is used for image recognition or any other similar software. At step 108, a single portfolio may have one attachment or multiple attachments. This is a single point of entry for the story teller to upload their content. At step 110, the portfolio may then store the content details in a DynamoDB, or any other database service that stores data in tables, and uploads the file to S3, or any other cloud-based storage service, in a private bucket. At step 112, the portfolio sends a work payload to AWS SQS, or any other communication software, to trigger the content module workflows on different parts, and the content module communicates with the SQS to receive the message and begin working with the content. At step 114, the system content starts the label extractor workflow for images that are synchronous, and the system gets the response immediately. For video content, the system starts the job in AWS Rekognition and begins monitoring the job for its status. A workflow starts for a single portfolio, then for each attachment in one portfolio, the system starts sub workflow to process each asset. At step 116, there is a single sub workflow for each asset management, for image Rekognition calls are synchronous, so in a single workflow, labels are collected and aggregated and then stored in the database against the asset. For Video, this Rekognition call is asynchronous. So once a video asset is shared, an explicit check on the video in a workflow is performed. This Rekognition job ID is then sent to waiting simple que service (SQS). The job is checked periodically in another workflow and if completed another job is submitted to Rekognition for label extraction. This also is sent to waiting SQS to be picked up later. After this label extraction is completed, aggregation and storage to the DB occurs. At step 118, labels are collected with confidence ranging from 40% to 100%, which leads to creation of the text search blob. At step 120, the asset is built and the existing database is updated. At step 122, DynamoDB (e.g., NoSQL database) event streams on insert/update. At step 124, DynamoDB streams event connected to Lambda to an SQS, which is being obtained by a search-feeds module. At step 126, the asset is registered with the defined details in a search service (e.g., AWS Kendra) as a Document. At step 128, query suggestions are created that are trending query from Kendra. In addition, a Kendra search with text through API, facets are supported as well. At step 130, as the explicit checks are completed and the content is of platform standard, processing the media asset to different formats for user interface supports begins. At step 132, images are processed with GaLanf Bimg library locally and placed in the S3, the formats are in the drawing. At step 134, videos are converted with a service that transcodes video files (e.g., AWS Elemental Media Convert) for different formats. At step 136, all processed outputs are stored in the S3 private path. They are exposed with a content delivery network (CDN) service, such as CloudFront. Users may view these assets through Cloudfront.

It will be understood that while various embodiments have been disclosed herein, other embodiments are contemplated. Further, certain embodiments of the present disclosure may include, incorporate, or otherwise comprise properties or features described in other embodiments. Consequently, various features of certain embodiments can be compatible with, combined with, included in, and/or incorporated into other embodiments of the present disclosure. Therefore, disclosure of certain features or components relative to a specific embodiment of the present disclosure should not be construed as limiting the application or inclusion of said features or components to the specific embodiment unless stated. As such, other embodiments can also include said features, components, members, elements, parts, and/or portions without necessarily departing from the scope of the present disclosure. The embodiments described herein are examples of the present disclosure. Accordingly, unless a feature or component is described as requiring another feature or component in combination therewith, any feature herein may be combined with any other feature of a same or different embodiment disclosed herein. Although only a few of the example embodiments have been described in detail herein, those skilled in the art will appreciate that modifications are possible without materially departing from the present disclosure described herein. Accordingly, all modifications may be included within the scope of this invention.

What is claimed is:

1. A method for a global visual content marketplace powered by geo-location and artificial intelligence, the method comprising:
uploading content that interacts with a portfolio module, where the portfolio module is instructed to communicate with a content module to check moderation labels prior to the content being uploaded.

2. The method of claim 1, wherein the content comprises images or videos.
